(19) United States
(12) Patent Application Publication
(10) Pub. No.: US 2023/0215134 A1
(43) Pub. Date: Jul. 6, 2023

(54) SYSTEM AND METHOD FOR IMAGE COMPARISON USING MULTI-DIMENSIONAL VECTORS

(71) Applicant: GM CRUISE HOLDINGS LLC, SAN FRANCISCO, CA (US)

(72) Inventors: Siddhartho Bhattacharya, Danville, CA (US); Craig Quiter, San Francisco, CA (US); Mayank Ketkar, San Francisco, CA (US); Wanlin Yang, Burlingame, CA (US); Sandeep Gangundi, San Jose, CA (US); Raluca Musaloiu-Elefteri, San Francisco, CA (US)

(21) Appl. No.: 17/568,455

(22) Filed: Jan. 4, 2022

(51) Int. Cl. G06V 10/74; G01S 17/86; G06F 7/02

(52) U.S. Cl. CPC G06V 10/761; G01S 17/86; G06F 7/023

(57) ABSTRACT

The disclosed technology provides solutions for finding samples from image data that are similar to failure cases, by constructing N-dimensional vectors of the failure cases. The vectors of failure cases are compared to other image data, with the objective of identifying groups of images that can be labeled. The labeled images are then used to retrain a model. Systems and machine-readable media are also provided.

### BACKGROUND

### 1. Technical Field

The disclosed technology provides solutions for improving models used for object detection and identification in autonomous vehicles (AVs) and in particular, for identifying N-dimensional vectors that can be used to describe objects for machine learning.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 conceptually illustrates an example of how particular dimensions of N-dimensional vectors might be displayed to help identify relationships between failure cases.

FIG. 2 illustrates a flow diagram of an example process for identifying relationships between failure cases, according to some aspects of the disclosed technology.

FIG. 3 illustrates a flow diagram of an example process for identifying relationships between failure cases, according to some aspects of the disclosed technology.

FIG. 4 illustrates an example system for managing one or more Autonomous Vehicles (AVs), according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Perception systems of autonomous vehicles are designed to detect various objects in the surrounding environment in order to execute effective navigation and planning operations. These perception systems use models that have been trained using labeled data. In many instances, the labeled data is image-based, and includes camera, LiDAR, and/or radar data.

Once a model has been trained, it can be validated and used against a larger image-based data set that is often not labeled. The trained model will correctly detect and identify some percentage of the objects in the larger data set. However, no model is completely accurate and it will fail to correctly detect and identify a different, and hopefully smaller percentage of objects in the larger data set. A failure might be a valid object detection, but an incorrect identification. Or, a failure might be a complete inability to detect an object. One objective therefore is to improve or retrain the model so it can correctly detect and identify even the failures.

Model training requires labeled training data. Randomly deciding which sensor data to label for training is costly and inefficient (because e.g. if the model is struggling with trucks making left turns, randomly labeling millions of additional images to add to the training dataset will probably label millions of cars/pedestrians/bicycles which the model might already be doing a good job detecting). Thus, an objective is to somehow automate a search process to find data (camera images, lidar pointclouds, etc.) that is similar to the data which our model performed poorly on (without explicitly limiting it to “please find examples of trucks turning left” from the above analogy, since there could be more failures that are harder to describe in plain english semantics, but should be easier using mathematical descriptors e.g. multidimensional vectors).

Using Artificial Intelligence/Machine Learning (AI/ML), it is possible to generate an N-dimensional vector that represents an object in image data. Some of the dimensions of the vector may be understandable to a human, such as a representation of length or height of the object. Another dimension might represent color, and another dimension might represent reflectivity. But the vector corresponding to the dimension itself is typically a number, such as between 0 and 1. While the dimension itself might have some meaning to a human, the numeric value of the vector will almost certainly not help a person understand what that vector represents. N in the N-dimensional vector might be hundreds or thousands, with most of the dimensions having no meaning to a human. However, for the AI/ML, that N-dimensional vector represents that object in that image data. If the AI/ML runs on images of related objects, there will be some similar vectors, meaning that the numeric values will be close to each other. For the dimensions that are understandable to a human, this makes sense. For example, if one of the dimensions represents object length, and two objects in different images have similar length, we can expect similar vectors related to length from the two images.

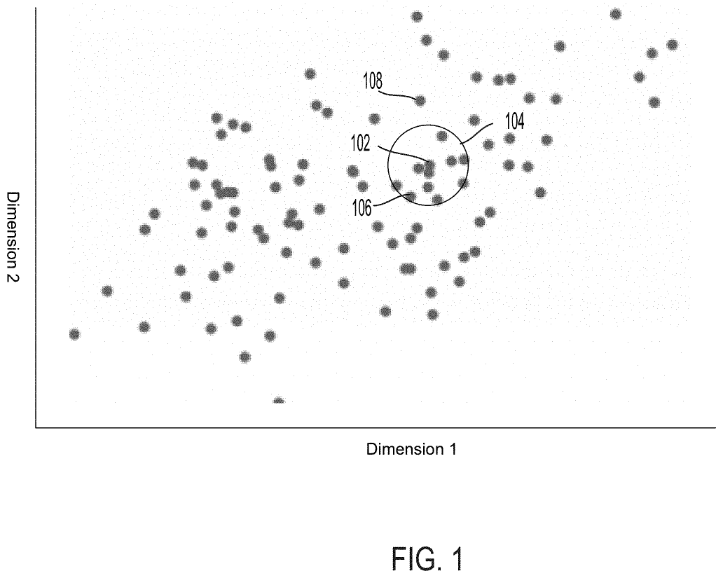

It is reasonably easy for a human to visualize and identify data clusters when the data is displayed in two dimensions. FIG. 1 illustrates one such display. It is possible to determine a distance between two data points, when represented in two dimensions. One is the Euclidean distance. If one point p has coordinates p1 and p2, and a second point q has coordinates q1 and q2, then a distance d between p and q is given by:

d(p, q)=\sqrt{(p1−q1)²+(p2−q2)²}

Although it is difficult for humans to visualized more than three dimensions, this is generally not a problem for the mathematics and computer modeling. The same mathematics applies in higher dimensions. In a similar fashion for points p and q, in N-dimensions, a distance d between p and q is given by:

d(p, q)=\sqrt{(p1−q1)²+(p2−q2)²+ . . . +(pn−qn)²}

Referring again to FIG. 1, we see two dimensions represented on the two axes. Plotted according to the two dimensions is a group of points, each representing a vector associated with an image. For example, a vector 102 associated with a failure case is surrounded by other vectors, some of which may be associated with other failure cases, and some may be associated with labeled cases. A circular distance 104 from vector 102 is illustrated. This distance can represent a threshold distance from vector 102. Any points that are plotted within distance 104 would be considered to be within or less than the threshold distance from vector 102. Any points that are plotted outside the threshold distance 104 would be considered to be beyond or greater than the threshold distance 104 from vector 102. As illustrated, vector 106 is within or less than the threshold distance 104 from vector 102. Vector 108 is beyond or greater than the threshold distance from vector 102. If the two dimensions reflect features that reasonably represent similar objects, then visual observation of the objects represented by vectors 102 and 106 may determine that both objects can be used to train the same feature. Likewise, visual observation of the objects represented by vectors 102 and 108 may determine that these are different types of objects and they should not be used to train the same feature.

Aspects of the disclosed technology provide solutions for generating N-dimensional vectors for failure cases, projecting selected dimensions of that N-dimensional vector in a two-dimensional (2D) space to aid visualization, projecting those selected dimensions of other cases in the same 2D space, and identifying images that are possibly similar to the failure cases, based on proximity of the projected vectors to each other.

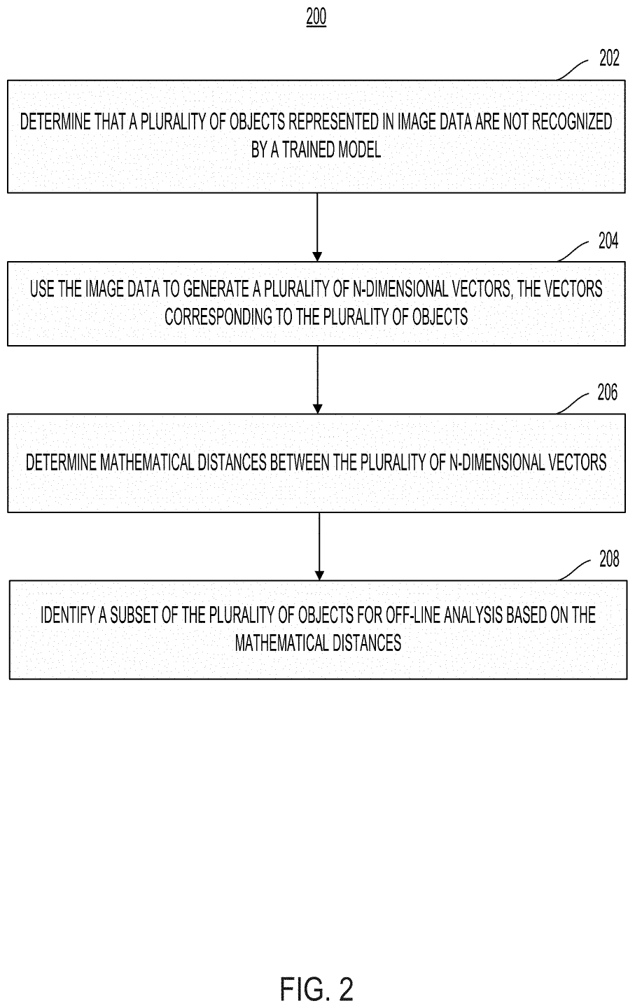

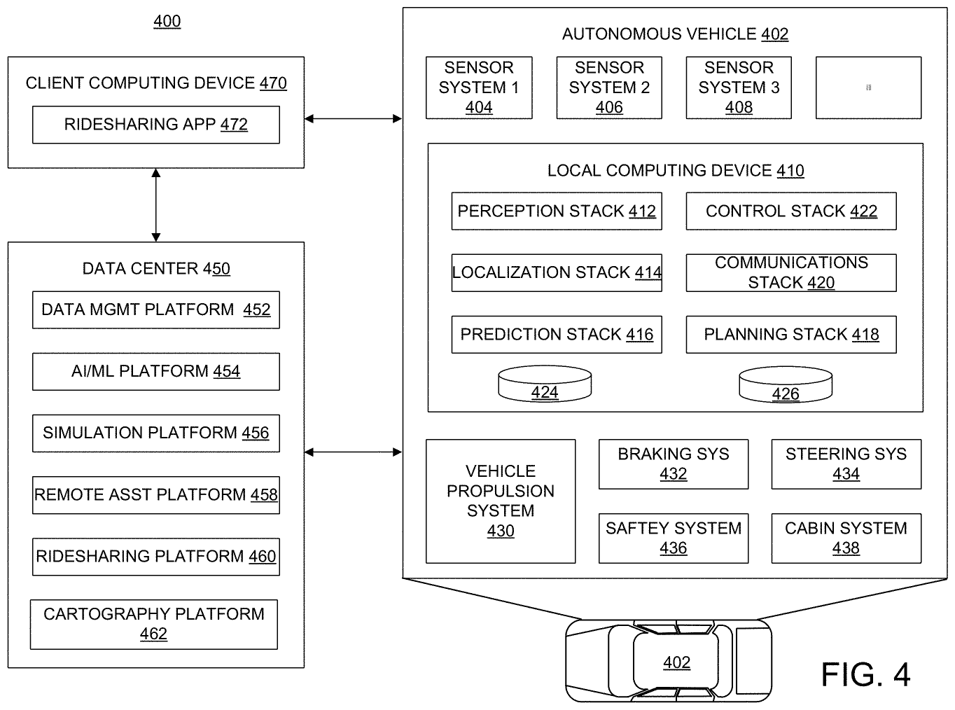

FIG. 2 illustrates a flow diagram of an example process 200, according to some aspects of the disclosed technology. At step 202, the process 200 includes determining that a plurality of objects, as the objects are represented in image data, are not recognized by a trained model. These actions may be performed by the AI/ML platform 454, illustrated in FIG. 4, and described below. These actions may be performed when the model is being validated, after training, and before the model is deployed. As an example, if a model was trained on a few thousand images, the validation might be performed on several hundreds of thousands of unlabeled images. The objects that are not recognized are failure cases, and even if their percentage of the total number of images is small, the failures could still number in the thousands.

At step 204, the process 200 includes using the image data to generate a plurality of N-dimensional vectors, the vectors corresponding to the plurality of objects. These actions may also be performed by the AI/ML platform 454. The number of dimensions (N) is not particularly important, but in many instances, it will be several hundred or even possibly thousands.

At step 206, the process 200 includes determining mathematical distances between the plurality of N-dimensional vectors. These may be Euclidian distances, determined according to the equations provided above. These actions may also be performed by the AI/ML platform 454.

At step 208, the process 200 includes identifying a subset of the plurality of objects for off-line analysis based on the mathematical distances. As illustrated in FIG. 1, a threshold distance may be helpful in identifying a cut-off for this off-line analysis. These actions may also be performed by the AI/ML platform 454.

A person may review the subset of the plurality of objects identified at step 208, to determine whether there are similarities in the objects that would allow labeling and then use of some or all of those images to retrain the model.

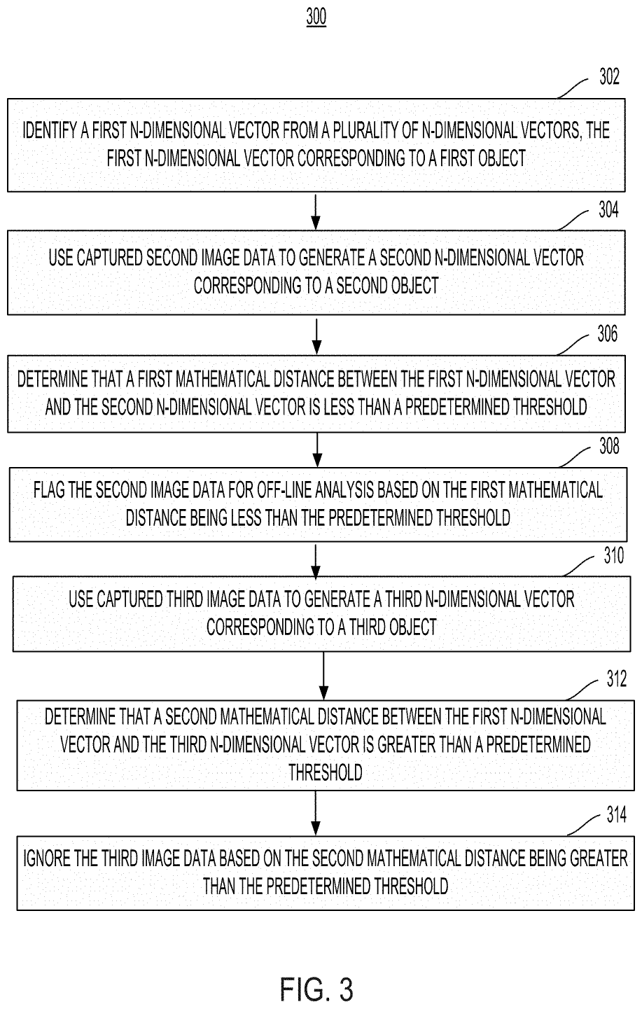

FIG. 3 illustrates a flow diagram of an example process 300, according to some aspects of the disclosed technology. At step 302, the process 300 includes identifying a first N-dimensional vector from a plurality of N-dimensional vectors. The first N-dimensional vector corresponds to a first object, and may be a failure case. These actions may also be performed by the AI/ML platform 454. Although not illustrated, the first N-dimensional vector may be provided to local computing device 410 of AV 402.

At step 304, the process 300 includes using captured second image data to generate a second N-dimensional vector corresponding to a second object. The second image data may be captured by at least one of the multiple sensor systems 404, 406, and 408, and perception stack 412 may be used to generate the second N-dimensional vector.

At step 306, the process 300 includes determining that a first mathematical distance between the first N-dimensional vector, and the second N-dimensional vector is less than a predetermined threshold. Conceptually, this is similar to determining whether the first N-dimensional vector 102 in FIG. 1 and the second N-dimensional vector 106 in FIG. 1 are less than the distance 104 of FIG. 1. Perception stack 412 may be used for the determination at step 306.

At step 308, the process 300 includes flagging the second image data for off-line analysis based on the first mathematical distance being less than the predetermined threshold. Perception stack 412 may be used for the determination at step 308.

At step 310, the process 300 includes using captured third image data to generate a third N-dimensional vector corresponding to a third object. The third image data may be captured by at least one of the multiple sensor systems 404, 406, and 408, and perception stack 412 may be used to generate the third N-dimensional vector.

At step 312, the process 300 includes determining that a second mathematical distance between the first N-dimensional vector, and the third N-dimensional vector is greater than the predetermined threshold. Conceptually, this is similar to determining whether the first N-dimensional vector 102 in FIG. 1 and the third N-dimensional vector 108 in FIG. 1 are separated by more than the distance 104 of FIG. 1. Perception stack 412 may be used for the determination at step 312.

At step 314, the process 300 includes ignoring the third image data based on the first mathematical distance being greater than the predetermined threshold. Perception stack 412 may be used for the determination at step 314.

FIG. 4 illustrates an example of an AV management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 402 can navigate roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., LiDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LiDAR system, and the sensor system 408 can be a RADAR system. Other embodiments may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some embodiments, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a prediction stack 416, a planning stack 418, a communications stack 420, a control stack 422, an AV operational database 424, and an HD geospatial database 426, among other stacks and systems.

The perception stack 412 can enable the AV 402 to “see” (e.g., via cameras, LiDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 414 can determine the AV's position and orientation (pose) using different methods from multiple systems (e.g., GPS, IMUs, cameras, LiDAR, RADAR, ultrasonic sensors, the HD geospatial database 426, etc.). For example, in some embodiments, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LiDAR). If the mapping and localization information from one system is unavailable, the AV 402 can use mapping and localization information from a redundant system and/or from remote data sources.

The prediction stack 416 can receive information from the localization stack 414 and objects identified by the perception stack 412 and predict a future path for the objects. In some embodiments, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

The planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

The control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

The communication stack 420 can transmit and receive signals between the various stacks and other components of the AV 402 and between the AV 402, the data center 450, the client computing device 470, and other remote systems. The communication stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 426 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408, stacks 412-422, and other components of the AV 402 and/or data received by the AV 402 from remote systems (e.g., the data center 450, the client computing device 470, etc.). In some embodiments, the raw AV data can include HD LiDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and the client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ridesharing platform 460, among other systems.

The data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the cartography platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the cartography platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from the cartography platform 462; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to pick up or drop off from the ridesharing application 472 and dispatch the AV 402 for the trip.

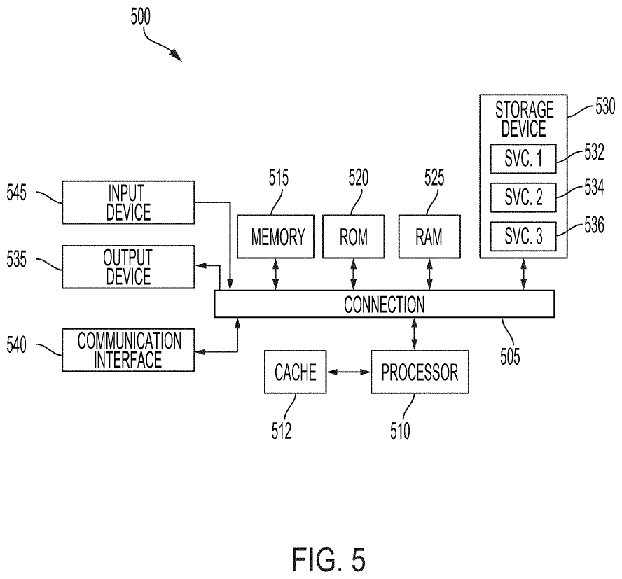

FIG. 5 illustrates an example processor-based system with which some aspects of the subject technology can be implemented. For example, processor-based system 500 can be any computing device making up local computing device 410, client computing device 470, a passenger device executing the rideshare app 472, data center 450, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Illustrative examples of the disclosure include:

Aspect 1. An autonomous vehicle, comprising: one or more environmental sensors; at least one memory; and at least one processor coupled to the at least one memory and the one or more environmental sensors, the at least one processor configured to: determine that a plurality of objects represented in image data captured by the environmental sensors are not recognized by a trained model; use the image data to generate a plurality of N-dimensional vectors, the vectors corresponding to the plurality of objects; determine mathematical distances between the plurality of N-dimensional vectors; and identify a subset of the plurality of objects for off-line analysis based on the mathematical distances.

Aspect 2. The autonomous vehicle of Aspect 1, wherein the at least one processor is further configured to: identify a first N-dimensional vector from the plurality of N-dimensional vectors, the first N-dimensional vector corresponding to a first object; use captured second image data to generate a second N-dimensional vector corresponding to a second object; determine that a first mathematical distance between the first N-dimensional vector and the second N-dimensional vector is less than a predetermined threshold; and flag the second image data for off-line analysis based on the first mathematical distance being less than the predetermined threshold.

Aspect 3. The autonomous vehicle of Aspect 2, wherein the at least one processor is further configured to: use captured third image data to generate a third N-dimensional vector corresponding to a third object; determine that a second mathematical distance between the first N-dimensional vector and the third N-dimensional vector is greater than the predetermined threshold; and ignore the third image data based on the second mathematical distance being greater than the predetermined threshold.

Aspect 4. The autonomous vehicle of any of Aspects 2 to 3, wherein the at least one processor is further configured to: provide the first N-dimensional vector to an autonomous vehicle; and capture the second image data using a sensor of the autonomous vehicle.

Aspect 5. The autonomous vehicle of any of Aspects 1 to 4, wherein determining the mathematical distances comprises determining Euclidian Distances between the plurality of N-dimensional vectors.

Aspect 6. The autonomous vehicle of any of Aspects 1 to 5, wherein the at least one processor is further configured to: identify a first dimension from the plurality of N-dimensional vectors; identify a second dimension from the plurality of N-dimensional vectors; and where the set of points correspond to at least a subset of the plurality of objects.

Aspect 7. The autonomous vehicle of any of Aspects 1 to 6, wherein the environmental sensors comprise one or more Light Detection and Ranging (LiDAR) sensors, camera sensors, thermal sensors, radar sensors, or a combination thereof.

Aspect 8. A computer-implemented method, comprising: determining that a plurality of objects represented in image data are not recognized by a trained model; using the image data to generate a plurality of N-dimensional vectors, the vectors corresponding to the plurality of objects; determining mathematical distances between the plurality of N-dimensional vectors; and identifying a subset of the plurality of objects for off-line analysis based on the mathematical distances.

Aspect 9. The computer-implemented method of Aspect 8, further comprising: identifying a first N-dimensional vector from the plurality of N-dimensional vectors, the first N-dimensional vector corresponding to a first object; using captured second image data to generate a second N-dimensional vector corresponding to a second object; determining that a first mathematical distance between the first N-dimensional vector and the second N-dimensional vector is less than a predetermined threshold; and flagging the second image data for off-line analysis based on the first mathematical distance being less than the predetermined threshold.

Aspect 10. The computer-implemented method of Aspect 9, further comprising: using captured third image data to generate a third N-dimensional vector corresponding to a third object; determining that a second mathematical distance between the first N-dimensional vector and the third N-dimensional vector is greater than the predetermined threshold; and ignoring the third image data based on the second mathematical distance being greater than the predetermined threshold.

Aspect 11. The computer-implemented method of any of Aspects 9 to 10, further comprising: providing the first N-dimensional vector to an autonomous vehicle; and capturing the second image data using a sensor of the autonomous vehicle.

Aspect 12. The computer-implemented method of any of Aspects 8 to 11, wherein determining the mathematical distances comprises determining Euclidian Distances between the plurality of N-dimensional vectors.

Aspect 13. The computer-implemented method of any of Aspects 8 to 12, further comprising: identifying a first dimension from the plurality of N-dimensional vectors; identifying a second dimension from the plurality of N-dimensional vectors; and where the set of points correspond to at least a subset of the plurality of objects.

Aspect 14. The computer-implemented method of any of Aspects 8 to 13, wherein the image data comprises Light Detection and Ranging (LiDAR) data, camera data, thermal camera data, radar data, or a combination thereof.

Aspect 15. A non-transitory computer-readable storage medium comprising at least one instruction for causing a computer or processor to: determine that a plurality of objects represented in image data captured by environmental sensors are not recognized by a trained model; use the image data to generating a plurality of N-dimensional vectors, the vectors corresponding to the plurality of objects; determine mathematical distances between the plurality of N-dimensional vectors; and identify a subset of the plurality of objects for off-line analysis based on the mathematical distances.

Aspect 16. The non-transitory computer-readable storage medium of Aspect 15, wherein the at least one instruction is further configured to cause the processor to: identify a first N-dimensional vector from the plurality of N-dimensional vectors, the first N-dimensional vector corresponding to a first object; use captured second image data to generate a second N-dimensional vector corresponding to a second object; determine that a first mathematical distance between the first N-dimensional vector and the second N-dimensional vector is less than a predetermined threshold; and flag the second image data for off-line analysis based on the first mathematical distance being less than the predetermined threshold.

Aspect 17. The non-transitory computer-readable storage medium of Aspect 16, wherein the at least one instruction is further configured to cause the processor to: use captured third image data to generate a third N-dimensional vector corresponding to a third object; determine that a second mathematical distance between the first N-dimensional vector and the third N-dimensional vector is greater than the predetermined threshold; and ignore the third image data based on the second mathematical distance being greater than the predetermined threshold.

Aspect 18. The non-transitory computer-readable storage medium of any of Aspects 16 to 17, wherein the at least one instruction is further configured to cause the processor to: provide the first N-dimensional vector to an autonomous vehicle; and capture the second image data using a sensor of the autonomous vehicle.

Aspect 19. The non-transitory computer-readable storage medium of any of Aspects 15 to 18, wherein determining the mathematical distances comprises determining Euclidian Distances between the plurality of N-dimensional vectors.

Aspect 20. The non-transitory computer-readable storage medium of any of Aspects 15 to 19, wherein the at least one instruction is further configured to cause the processor to: identify a first dimension from the plurality of N-dimensional vectors; identify a second dimension from the plurality of N-dimensional vectors; and display a set of points in a two-dimensional array plotted with the first dimension as a first axis of the two-dimensional array, and the second dimension as a second axis of the two-dimensional array, where the set of points correspond to at least a subset of the plurality of objects.

Aspect 21. A system comprising means for performing a method according to any of Aspects 8 to 14.

What is claimed is:

1. An autonomous vehicle, comprising:
one or more environmental sensors;
at least one memory; and
at least one processor coupled to the at least one memory and the one or more environmental sensors, the at least one processor configured to:
determine that a plurality of objects represented in image data captured by the environmental sensors are not recognized by a trained model;
use the image data to generate a plurality of N-dimensional vectors, the vectors corresponding to the plurality of objects;
determine mathematical distances between the plurality of N-dimensional vectors; and
identify a subset of the plurality of objects for off-line analysis based on the mathematical distances.

2. The autonomous vehicle of claim 1, wherein the at least one processor is further configured to:
identify a first N-dimensional vector from the plurality of N-dimensional vectors, the first N-dimensional vector corresponding to a first object;
use captured second image data to generate a second N-dimensional vector corresponding to a second object;
determine that a first mathematical distance between the first N-dimensional vector and the second N-dimensional vector is less than a predetermined threshold; and
flag the second image data for off-line analysis based on the first mathematical distance being less than the predetermined threshold.

3. The autonomous vehicle of claim 2, wherein the at least one processor is further configured to:
use captured third image data to generate a third N-dimensional vector corresponding to a third object;
determine that a second mathematical distance between the first N-dimensional vector and the third N-dimensional vector is greater than the predetermined threshold; and
ignore the third image data based on the second mathematical distance being greater than the predetermined threshold.

4. The autonomous vehicle of claim 2, wherein the at least one processor is further configured to:
provide the first N-dimensional vector to an autonomous vehicle; and
capture the second image data using a sensor of the autonomous vehicle.

5. The autonomous vehicle of claim 1, wherein determining the mathematical distances comprises determining Euclidian Distances between the plurality of N-dimensional vectors.

6. The autonomous vehicle of claim 1, wherein the at least one processor is further configured to:
identify a first dimension from the plurality of N-dimensional vectors;
identify a second dimension from the plurality of N-dimensional vectors; and
display a set of points in a two-dimensional array plotted with the first dimension as a first axis of the two-dimensional array, and the second dimension as a second axis of the two-dimensional array, where the set of points correspond to at least a subset of the plurality of objects.

7. The autonomous vehicle of claim 1, wherein the environmental sensors comprise one or more Light Detection and Ranging (LiDAR) sensors, camera sensors, thermal sensors, radar sensors, or a combination thereof.

8. A computer-implemented method, comprising:
determining that a plurality of objects represented in image data are not recognized by a trained model;
using the image data to generate a plurality of N-dimensional vectors, the vectors corresponding to the plurality of objects;
determining mathematical distances between the plurality of N-dimensional vectors; and
identifying a subset of the plurality of objects for off-line analysis based on the mathematical distances.

9. The computer-implemented method of claim 8, further comprising:
identifying a first N-dimensional vector from the plurality of N-dimensional vectors, the first N-dimensional vector corresponding to a first object;
using captured second image data to generate a second N-dimensional vector corresponding to a second object;
determining that a first mathematical distance between the first N-dimensional vector and the second N-dimensional vector is less than a predetermined threshold; and
flagging the second image data for off-line analysis based on the first mathematical distance being less than the predetermined threshold.

10. The computer-implemented method of claim 9, further comprising:
using captured third image data to generate a third N-dimensional vector corresponding to a third object;
determining that a second mathematical distance between the first N-dimensional vector and the third N-dimensional vector is greater than the predetermined threshold; and
ignoring the third image data based on the second mathematical distance being greater than the predetermined threshold.

11. The computer-implemented method of claim 9, further comprising:
providing the first N-dimensional vector to an autonomous vehicle; and
capturing the second image data using a sensor of the autonomous vehicle.

12. The computer-implemented method of claim 8, wherein determining the mathematical distances comprises determining Euclidian Distances between the plurality of N-dimensional vectors.

13. The computer-implemented method of claim 8, further comprising:
identifying a first dimension from the plurality of N-dimensional vectors;
identifying a second dimension from the plurality of N-dimensional vectors; and
displaying a set of points in a two-dimensional array plotted with the first dimension as a first axis of the two-dimensional array, and the second dimension as a second axis of the two-dimensional array, where the set of points correspond to at least a subset of the plurality of objects.

14. The computer-implemented method of claim 8, wherein the image data comprises Light Detection and Ranging (LiDAR) data, camera data, thermal camera data, radar data, or a combination thereof.

15. A non-transitory computer-readable storage medium comprising at least one instruction for causing a computer or processor to:
determine that a plurality of objects represented in image data captured by environmental sensors are not recognized by a trained model;
use the image data to generate a plurality of N-dimensional vectors, the vectors corresponding to the plurality of objects;
determine mathematical distances between the plurality of N-dimensional vectors; and
identify a subset of the plurality of objects for off-line analysis based on the mathematical distances.

16. The non-transitory computer-readable storage medium of claim 15, wherein the at least one instruction is further configured to cause the processor to:
identify a first N-dimensional vector from the plurality of N-dimensional vectors, the first N-dimensional vector corresponding to a first object;
use captured second image data to generate a second N-dimensional vector corresponding to a second object;
determine that a first mathematical distance between the first N-dimensional vector and the second N-dimensional vector is less than a predetermined threshold; and
flag the second image data for off-line analysis based on the first mathematical distance being less than the predetermined threshold.

17. The non-transitory computer-readable storage medium of claim 16, wherein the at least one instruction is further configured to cause the processor to:
use captured third image data to generate a third N-dimensional vector corresponding to a third object;
determine that a second mathematical distance between the first N-dimensional vector and the third N-dimensional vector is greater than the predetermined threshold; and
ignore the third image data based on the second mathematical distance being greater than the predetermined threshold.

18. The non-transitory computer-readable storage medium of claim 16, wherein the at least one instruction is further configured to cause the processor to:
provide the first N-dimensional vector to an autonomous vehicle; and
capture the second image data using a sensor of the autonomous vehicle.

19. The non-transitory computer-readable storage medium of claim 15, wherein determining the mathematical distances comprises determining Euclidian Distances between the plurality of N-dimensional vectors.

20. The non-transitory computer-readable storage medium of claim 15, wherein the at least one instruction is further configured to cause the processor to:
identify a first dimension from the plurality of N-dimensional vectors;
identify a second dimension from the plurality of N-dimensional vectors; and
display a set of points in a two-dimensional array plotted with the first dimension as a first axis of the two-dimensional array, and the second dimension as a second axis of the two-dimensional array, where the set of points correspond to at least a subset of the plurality of objects.
